(19) United States
(12) Patent Application Publication
(10) Pub. No.: US 2026/0128534 A1
(43) Pub. Date: May 7, 2026

(54) VEHICLE-MOUNTED COMBINED ANTENNA AND ELECTRONIC DEVICE

(71) Applicant: Quectel Wireless Solutions Co., Ltd., Shanghai (CN)

(72) Inventors: Mingjun HANG, Shanghai (CN); Wei GU, Shanghai (CN); Junsen LI, Shanghai (CN)

(73) Assignee: Quectel Wireless Solutions Co., Ltd., Shanghai (CN)

(21) Appl. No.: 19/437,196

(22) Filed: Dec. 30, 2025

Related U.S. Application Data
(63) Continuation of application No. PCT/CN2023/122237, filed on Sep. 27, 2023.

(51) Int. Cl. H01Q 21/28; H01Q 1/12; H01Q 1/32; H01Q 1/52

(52) U.S. Cl. CPC H01Q 21/28; H01Q 1/12; H01Q 1/32; H01Q 1/52

(57) ABSTRACT

In embodiments of the present application, signals received by a plurality of first antennas can be transmitted to a T-BOX through a first wiring harness. Correspondingly, the plurality of first antennas can also receive signals transmitted from the T-BOX through the first wiring harness and transmit the signals. Moreover, signals received by a second antenna can be transmitted to the T-BOX and a P-BOX through a second wiring harness and a third wiring harness, respectively, to facilitate positioning and network communication.

### CROSS-REFERENCE TO RELATED APPLICATIONS

The present application is a continuation of International Application No. PCT/CN2023/122237, filed on Sep. 27, 2023, the disclosure of which is hereby incorporated by reference in its entirety.

### TECHNICAL FIELD

The present application relates to the technical field of antennas, in particular to a vehicle-mounted combined antenna and an electronic device.

### BACKGROUND

With the continuous advancement of automobile intelligence and networking, vehicle-to-everything technology is becoming increasingly mature. Vehicle-to-everything refers to the interconnection and communication between automobiles and everything else. As a front-end component of an entire vehicle-to-everything system, vehicle-mounted antennas are needed for positioning and transmitting all location data and communication data. Therefore, the performance of the vehicle-mounted antennas directly affects the performance of the entire vehicle-to-everything system.

In conventional schemes, vehicle-mounted antennas are designed inside a telematics communication unit (Telematics BOX, T-BOX). Since the T-BOX contains various communication components such as a radio frequency circuit and a power amplifier, the internal space is limited. As a result, when multiple antennas are integrated into the T-BOX, their distribution is relatively compact, which is prone to poor antenna isolation. In addition, the radio frequency circuit and the like produce electromagnetic waves during operation, which can cause electromagnetic interference to the antennas and affect the transceiving performance of the antennas.

Therefore, the vehicle-mounted antenna solutions provided in the conventional schemes cannot meet the requirements of current automobiles for vehicle communication.

### SUMMARY

Embodiments of the present application are directed to provide a vehicle-mounted combined antenna and an electronic device, as described below in the following aspects.

In a first aspect, a vehicle-mounted combined antenna is provided. The vehicle-mounted combined antenna includes a circuit board, a first wiring harness, a second wiring harness and a third wiring harness. The circuit board is provided with a plurality of first antennas and at least one second antenna, the first wiring harness is connected with the plurality of first antennas through the circuit board, the second wiring harness and the third wiring harness are both connected with the second antenna through the circuit board, the first wiring harness and the second wiring harness are connected with a telematics communication unit, and the third wiring harness is connected with a vehicle positioning module.

In one of the embodiments, the second antenna is arranged in a central area of the circuit board, and the plurality of first antennas are arranged on three sides of the circuit board.

In one of the embodiments, a first antenna having a high antenna frequency among the plurality of first antennas is arranged on a long side of the circuit board, and a first antenna having a low antenna frequency is arranged on a short side of the circuit board.

In one of the embodiments, the vehicle-mounted combined antenna further includes a shielding cover, where the shielding cover is arranged in a central area of a side face, facing away from the second antenna, of the circuit board.

In one of the embodiments, the vehicle-mounted combined antenna further includes a power division feeding module, where the power division feeding module is located on the circuit board and arranged between the second antenna and the second and third wiring harnesses.

In one of the embodiments, the vehicle-mounted combined antenna further includes a first housing and a second housing, where the first housing and the second housing are snap-fitted to form an accommodating chamber, the circuit board is mounted in the accommodating chamber, and the first wiring harness, the second wiring harness and the third wiring harness extend out of the accommodating chamber.

In one of the embodiments, the plurality of first antennas are hot-melted on the first housing by using steel sheets.

In one of the embodiments, the plurality of first antennas include two 5G MIMO antennas, one 5G Main antenna and one 5G diversity antenna, and the second antenna is a ceramic high-precision positioning antenna or a global navigation satellite system (GNSS) active antenna.

In one of the embodiments, a fixing lug is arranged on a short side of the first housing, the fixing lug includes a reinforcing rib and a fixing sheet, and the fixing sheet is provided with a fixing hole.

In a second aspect, an electronic device is provided, including: a telematics communication unit, a vehicle positioning module and the vehicle-mounted combined antenna as disclosed in the first aspect above. The vehicle-mounted combined antenna is connected with the telematics communication unit and the vehicle positioning module.

In the embodiments of the present application, signals received by the plurality of first antennas may be transmitted to a T-BOX through the first wiring harness. Correspondingly, the plurality of first antennas may also receive signals transmitted from the T-BOX through the first wiring harness and transmit the signals. Moreover, signals received by the second antenna may be transmitted to the T-BOX and a P-BOX through the second wiring harness and the third wiring harness, respectively, to facilitate positioning and network communication. Through the first wiring harness, the second wiring harness, and the third wiring harness, a distance between the vehicle-mounted combined antenna and the T-Box, as well as positions of the vehicle-mounted combined antenna and the T-Box can be more flexibly configured. Thus, a mounting position of the vehicle-mounted combined antenna is no longer constrained or limited by a layout position of the T-BOX, and a signal shielding area can be flexibly avoided.

### BRIEF DESCRIPTION OF THE DRAWINGS

FIG. 1 shows a schematic diagram of a vehicle-mounted combined antenna provided by an embodiment of the present application.

FIG. 2 shows a schematic diagram of a circuit board.

FIG. 3 shows an example of a circuit structure diagram of a power division feeding module.

FIG. 4 shows a schematic diagram of a housing of a vehicle-mounted combined antenna.

FIG. 5 shows a schematic diagram of a circuit board assembled in a first housing.

FIG. 6 shows a schematic exploded view of a six-in-one combined antenna.

FIG. 7 shows a schematic diagram of voltage standing wave ratios of respective first antennas.

FIG. 8 shows a schematic diagram of a voltage standing wave ratio of a second antenna.

FIG. 9 shows isolation between antennas.

FIG. 10 shows a structural block diagram of an electronic device.

### DETAILED DESCRIPTION OF THE EMBODIMENTS

Technical solutions in embodiments of the present application will be clearly described below in conjunction with accompanying drawings in the embodiments of the present application. Apparently, the described embodiments are only part of the embodiments of the present application, not all of them.

Vehicle-to-everything (Connected Car) refers to technologies and applications that enable information interaction and data sharing between vehicles, between vehicles and traffic infrastructure, and between vehicles and users by connecting automobiles to the Internet by using wireless communication technologies. The vehicle-to-everything can realize functions such as remote monitoring, remote diagnosis, remote control, and remote upgrading of vehicles, provide services such as navigation, entertainment, safety, and rescue, enhancing driving experience and improving traffic safety and efficiency.

Vehicle-mounted antennas are key components for realizing intelligent networked functions such as radio communication, wireless networks, and satellite positioning, and play a key role in transmitting and receiving signals for communication systems.

In conventional schemes, most vehicle-mounted antennas are designed inside a T-BOX. Due to the influence of radio frequency circuit design inside the T-BOX, the space for the vehicle-mounted antennas is squeezed, resulting in poor isolation between a plurality of vehicle-mounted antennas and adverse impacts on performance of the antennas.

In addition, the vehicle-mounted antennas are designed inside the T-BOX, so electromagnetic interference generated by a radio frequency circuit and surrounding circuits thereof will also affect the performance of the vehicle-mounted antennas. Moreover, the vehicle-mounted antennas can only be arranged along with the T-BOX, meaning that locations of the vehicle-mounted antennas are limited to where the T-BOX is mounted. If the T-BOX is arranged right in a signal shielding area, the signal quality of the vehicle-mounted antennas will be extremely poor, directly affecting the network communication performance of a vehicle after assembly.

In recent years, with the introduction of 5G technology and the application of multiple-input multiple-output (MIMO), the number of vehicle-mounted antennas has been increasing, even reaching 10-20 or more. The increase in the number of the vehicle-mounted antennas has brought obstacles to assembly, mounting, and post-mounting management. Therefore, multi-antenna integration has become a development trend for the vehicle-mounted antennas.

In order to solve the above technical problems, an embodiment of the present application provides a vehicle-mounted combined antenna. The vehicle-mounted combined antenna includes a circuit board, a first wiring harness, a second wiring harness and a third wiring harness. The circuit board is provided with a plurality of first antennas and at least one second antenna, the first wiring harness is connected with the plurality of first antennas through the circuit board, the second wiring harness and the third wiring harness are both connected with the second antenna through the circuit board, the first wiring harness and the second wiring harness are connected with a telematics communication unit, and the third wiring harness is connected with a vehicle positioning module. In embodiment of the present application, the vehicle-mounted antennas are arranged separately to form physical isolation from a T-BOX. This can avoid space limitation inside the T-BOX and electromagnetic interference from a radio frequency circuit and surrounding circuits thereof in the T-BOX. In addition, mounting locations of the vehicle-mounted antennas are no longer affected by a layout of the T-BOX, so that a signal shielding area can be flexibly avoided.

The vehicle-mounted combined antenna provided by embodiments of the present application is described in detail below with reference to the accompanying drawings.

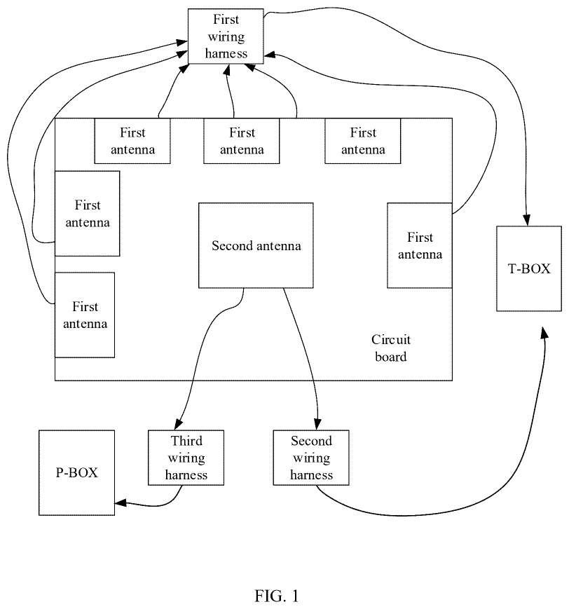

As shown in FIG. 1, FIG. 1 shows a schematic diagram of a vehicle-mounted combined antenna provided by an embodiment of the present application. The vehicle-mounted combined antenna includes a circuit board 3, a first wiring harness, a second wiring harness and a third wiring harness. The circuit board 3 is provided with a plurality of first antennas 4 and at least one second antennas 5, the first wiring harness is connected with the plurality of first antennas 4 through the circuit board 3, and the second wiring harness and the third wiring harness are both connected with the second antennas 5.

The first wiring harness includes an FAKRA connector and a radio frequency cable. The radio frequency cable 14 is capable of transmitting signals effectively, maintaining the stability and completeness of the signals, reducing attenuation and interference of the signals, and improving communication quality and performance. In the embodiment of the present application, one end of the radio frequency cable 14 is connected with the FAKRA connector, and the other end of the radio frequency cable 14 is connected with the first antennas 4 through the circuit board 3. The FAKRA connector is configured to be connected to a telematics communication unit T-BOX.

The second wiring harness and the third wiring harness have a similar structure as the first wiring harness, and each include an FAKRA connector and a radio frequency cable. One end of the radio frequency cable 14 of the second wiring harness is connected with the second antennas 5, and the FAKRA connector 10 of the second wiring harness is connected to the T-BOX. One end of the radio frequency cable 14 of the third wiring harness is connected with the second antennas 5, and the FAKRA connector 11 of the third wiring harness is connected to a vehicle positioning module P-BOX.

The T-BOX is mainly responsible for vehicle communication networking, and its core is a 4G/5G/6G communication module. The vehicle positioning module P-BOX is mainly responsible for vehicle positioning, and its core is a GNSS signal receiving and calculation module.

In the embodiment of the present application, the first wiring harness is a multi-in-one harness, that is, the first wiring harness includes a plurality of radio frequency cables, and one of the radio frequency cables is connected with one first antenna. For example, the number of the first antennas 4 is 4, and then the first wiring harness is a four-in-one harness. Each radio frequency cable 14 may be independently connected with one FAKRA connector, thus being connected with the telematics communication unit independently. Alternatively, the plurality of radio frequency cables may share one FAKRA connector, thus being connected with the telematics communication unit through the one FAKRA connector.

In some implementations, the plurality of radio frequency cables are wrapped and fixed by fleece tape 7 and cable tie clips 8.

In the embodiment of the present application, signals received by the plurality of first antennas 4 may be transmitted to the T-BOX through the first wiring harness. Correspondingly, the plurality of first antennas 4 may also receive signals transmitted from the T-BOX through the first wiring harness and transmit the signals. Moreover, signals received by the second antennas 5 may be transmitted to the T-BOX and the P-BOX through the second wiring harness and the third wiring harness, respectively, to facilitate positioning and network communication. Through the first wiring harness, the second wiring harness, and the third wiring harness, a distance between the vehicle-mounted combined antenna and the T-Box, as well as the positions of the vehicle-mounted combined antenna and the T-Box can be more flexibly configured. Thus, a mounting position of the vehicle-mounted combined antenna is no longer constrained or limited by a layout position of the T-BOX, and a signal shielding area can be flexibly avoided.

Based on the above embodiment, the first antennas 4 and the second antennas 5 involved in the embodiment of the present application are described below.

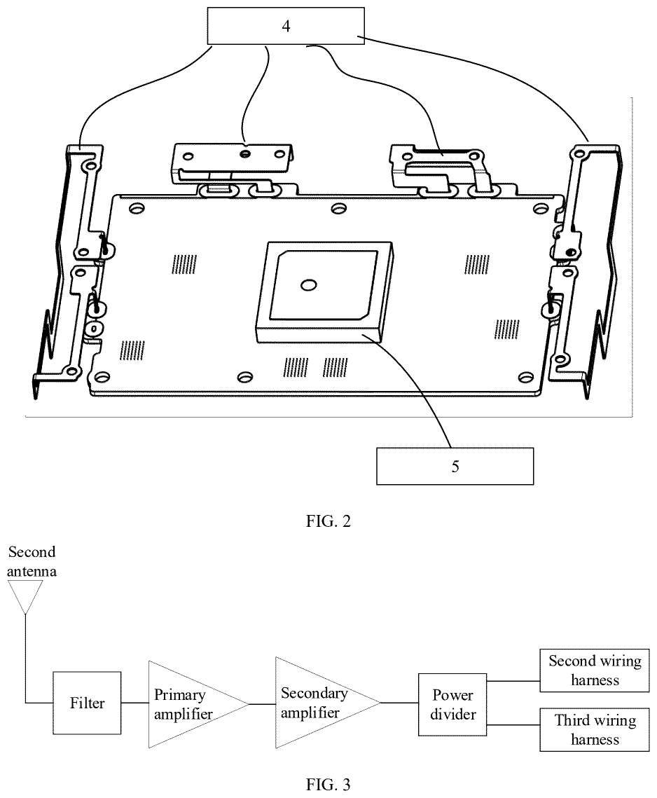

In the embodiment of the present application, the second antennas 5 is arranged in a central area of the circuit board 3, and the plurality of first antennas 4 are arranged on three sides of the circuit board 3. Referring to FIG. 2, FIG. 2 shows a schematic diagram of the circuit board 3. FIG. 2 shows an example of four first antennas 4 and one second antennas 5. Two of the four first antennas 4 are located on a long side of the circuit board 3, and the other two first antennas 4 are located on two short sides of the circuit board 3 respectively. The one second antennas 5 is arranged on a plane of the circuit board 3.

In an optional implementation, a first antenna having a high antenna frequency among the plurality of first antennas 4 is arranged on a long side of the circuit board 3, and a first antenna having a low antenna frequency is arranged on a short side of the circuit board 3. In this mode, space in the vehicle-mounted combined antenna can be used more properly, thus improving isolation between the antennas.

A distance between the first antennas 4 arranged on the long side is greater than one half or a quarter of a wavelength of the two antennas. Otherwise, the two antennas may produce signal interference. The higher the frequency of the antennas, the shorter the corresponding signal wavelength, and in this case, the distance between the antennas may be set relatively short without interference. The lower the frequency of the antennas, the longer the corresponding signal wavelength, and in this case, the distance between the antennas needs to be set relatively longer. As can be seen, a first antenna having a low antenna frequency has a relatively high requirement for the distance between antennas, and therefore, by independently arranging the first antenna having a low antenna frequency on a short side of the circuit board 3, a distance between the first antenna having a low antenna frequency and another antenna is increased, avoiding mutual interference.

As shown in FIG. 2, two first antennas 4 are arranged on a long side of the circuit board 3 in FIG. 2. The two first antennas 4 may be first antennas 4 having high antenna frequencies among the plurality of first antennas 4, so that the two first antennas 4 have a low requirement for the distance therebetween, which can achieve high isolation conveniently.

In an implementation, the plurality of first antennas 4 may be a plurality of identical antennas, or a plurality of antennas that are completely different from each other, or a plurality of antennas that are partially identical. When the plurality of first antennas 4 are the plurality of identical antennas, the plurality of identical antennas may be blind-mated.

In some implementations, the plurality of first antennas 4 are flexible circuit board 3 antennas. In some implementations, the plurality of first antennas 4 may include low and medium frequency antennas, and also include medium and high frequency antennas. In some implementations, the plurality of first antennas 4 are planar inverted F-shaped antennas (PIFAs).

In some implementations, frequency coverage of the first antennas 4 ranges from 600 MHz to 960 MHz and from 1710 MHz to 6000 MHz, and frequency bands of multiple standards such as 4G LTE, 5G NR, WiFi, V2X, and GPS are contained in the frequency coverage. Optionally, the plurality of first antennas 4 may include any one or more of a WiFi 2.4G antenna, a WiFi 5G antenna, a vehicle-to-everything (V2X) antenna, a long term evolution (LTE) 4G antenna, a 5G New Radio (5G NR) antenna, a 5G MIMO antenna, a 5G Main antenna, or a 5G diversity antenna. WiFi 2.4G refers to WiFi that operates on a 2.4 Ghz radio wave frequency band. WiFi 5G refers to WiFi that operates on a 5 Ghz radio wave frequency band.

Optionally, the plurality of first antennas 4 include two 5G MIMO antennas, one 5G Main antenna, and one 5G diversity antenna. In an implementation, the two 5G MIMO antennas are located on a long side of the circuit board 3, and the one 5G Main antenna and the one 5G diversity antenna are located on two short sides of the circuit board 3 respectively. Frequency coverage of the 5G Main antenna and 5G diversity antenna ranges from 600 MHz to 960 MHz, and from 1710 MHz to 6000 MHz, and frequency coverage of the two 5G MIMO antennas ranges from 1710 MHz to 6000 MHz. Optionally, the 5G Main antenna and the 5G diversity antenna may be blind-mated.

In an optional implementation, the 5G Main antenna and the 5G diversity antenna are in a form of LOOP antennas, where the form of LOOP antennas may effectively increase a low-frequency bandwidth.

Based on the above embodiments, in an embodiment of the present application, the second antennas 5 is a ceramic high-precision positioning antenna or a GNSS active antenna.

When the second antennas 5 is the GNSS active antenna, since the active antenna is generally configured with a signal amplifying circuit and other possible surrounding circuits, these circuits may generate electromagnetic interference on other first antennas 4 during operation. In order to solve this problem, in the embodiment of the present application, as shown in FIG. 2, the vehicle-mounted combined antenna further includes a shielding cover 12, where the shielding cover 12 is arranged in a central area of a side face, facing away from the second antennas 5, of the circuit board 3. That is to say, the shielding cover 12 and the second antennas 5 are arranged at a same position on two opposite side faces of the circuit board 3, such that the shielding cover 12 may perform electromagnetic shielding on the surrounding circuits of the GNSS active antenna to avoid interference on other first antennas 4.

In some implementations, frequency coverage of the GNSS active antenna ranges from 1559 MHz to 1606 MHz, supporting a GPS L1 frequency band, a GPS L5 frequency band, a Beidou navigation satellite system (BDS) B1 frequency band, a Russian global navigation satellite system (GLONASS) G1 frequency band, a Galileo multi-satellite system (GALILEO) E1 frequency band, and the like. The B1 frequency band is in a range from 1559 MHz to 1563 MHz, with a frequency of 1561.098±2.046 MHz. A frequency range of the GLONASS G1 signal frequency band ranges from 1598.0625 MHz to 1605.375 MHz. A signal frequency of the GALILEO E1 is 1575.42 MHz.

In some implementations, when there are two second antennas, the two second antennas are identical antennas. The second wiring harness and the third wiring harness are both connected to one second antenna. Since the two second antennas are identical antennas, signals received by the two may also be considered identical. In this case, one signal is transmitted to the T-BOX via the second wiring harness, and the other signal is transmitted to the P-BOX via the third wiring harness.

In some other implementations, when there is one second antenna, the vehicle-mounted combined antenna further includes a power division feeding module, where the power division feeding module is located on the circuit board 3 and arranged between the second antennas 5 and the second and third wiring harnesses.

In an implementation, the power division feeding module includes an input port and two output ports, where the input port is connected with the second antennas 5, and the two output ports are connected with the second wiring harness and the third wiring harness, respectively.

In another implementation, as shown in FIG. 3, FIG. 3 shows an example of a circuit structure diagram of a power division feeding module. The power division feeding module includes a filter, a primary amplifier, a secondary amplifier, and a power divider. After the second antennas 5 receives a signal, the signal is filtered by the filter, then amplified by the primary amplifier and the secondary amplifier, and finally divided into two signals by the power divider. The two signals are output to the second wiring harness and the third wiring harness via the two output ports and finally transmitted to the T-BOX and the P-BOX, respectively.

In the embodiment of the present application, the two signals are output through one second antennas 5 and the power division feeding module, one signal is provided to vehicle computer navigation to use the P-BOX, and the other signal is provided to the T-BOX for use, which achieves a low cost.

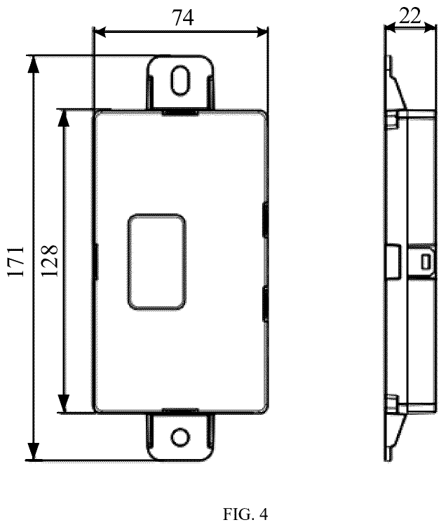

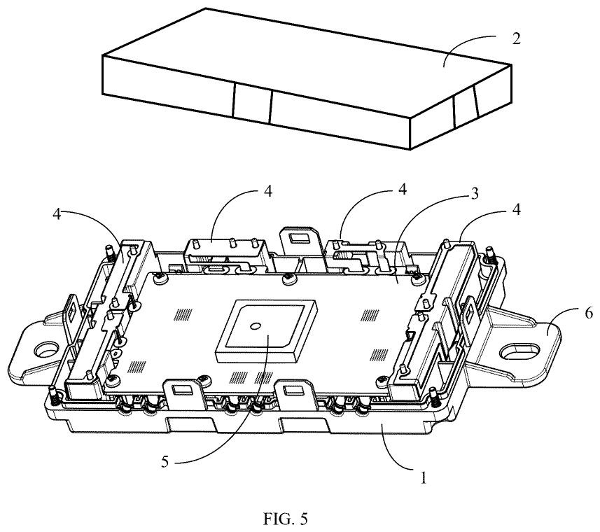

Based on the above embodiments, the vehicle-mounted combined antenna provided by an embodiment of the present application further includes a first housing 2 and a second housing 1. As shown in FIG. 4 and FIG. 5, FIG. 4 shows a schematic diagram of a housing of a vehicle-mounted combined antenna. FIG. 5 shows a schematic diagram of a circuit board 3 assembled in a first housing 2.

The first housing 2 and the second housing 1 are snap-fitted to form an accommodating chamber, the circuit board 3 is mounted in the accommodating chamber, and the first wiring harness, the second wiring harness and the third wiring harness extend out of the accommodating chamber.

In some implementations, the first housing 2 and the second housing 1 are non-metal housings, and optionally, the first housing 2 and the second housing 1 are plastic housings or resin-material housings.

In some implementations, the first housing 2 and the second housing 1 may be in any shape. In some implementations, shapes of the first housing 2 and the second housing 1 are the same as a shape of the circuit board 3.

In some implementations, the first housing 2 and the second housing 1 are connected through a screw 13. In some implementations, the first housing 2 and the second housing 1 are welded through an ultrasonic hot-melting technology.

In some implementations, a shell formed after the first housing 2 and the second housing 1 are closed can achieve an IP52 waterproof level.

As shown in FIG. 4 and FIG. 5, in embodiments of the present application, a fixing lug is arranged on a short side of the first housing 2, the fixing lug includes a reinforcing rib and a fixing sheet, and the fixing sheet is provided with a fixing hole.

The fixing hole is a threaded hole or a through hole. The fixing sheet and the reinforcing rib are connected with a side edge of the first housing 2.

In an implementation, one or more fixing lugs are arranged on one short side of the first housing 2.

In some other implementations, one or more fixing lugs are arranged on each of two short sides of the first housing 2. On the housing shown in FIG. 4, two short sides of the first housing 2 are each provided with one fixing lug.

In the embodiment of the present application, the stability and reliability of the antenna are enhanced by directly integrating the fixing lug and the first housing 2.

As shown in FIG. 4, in the embodiment of the present application, a size of the first housing 2 and the second housing 1 is 128 mm×74 mm×22 mm. The fixing lugs on the two sides increase a total length of the antenna to 171 mm.

In an implementation, as shown in FIG. 5, the plurality of first antennas 4 are welded on the first housing 2 so as to be fixed. Optionally, the plurality of first antennas 4 are hot-melted on the first housing 2 by using steel sheets so as to be fixed. Power feed of the antennas is achieved by welding the antennas and the circuit board 3. Such connection mode can well ensure that the vehicle-mounted combined antenna has a good anti-vibration characteristic when used on various vehicle systems.

FIG. 5 shows four first antennas 4, and the four first antennas 4 are hot-melted on the first housing 2 by using steel sheets so as to be fixed.

The vehicle-mounted combined antenna provided by the embodiments of the present application has the following advantages.
1. The miniaturized vehicle-mounted combined antenna has the characteristics of high integration and flexible assembly, with as many antennas as possible arranged within an internal smallest possible space, so that the space pressure of a communication system is reduced, and the miniaturized vehicle-mounted combined antenna requires a smaller space.
2. The miniaturized vehicle-mounted combined antenna may adapt to more mounting environments, and the more uniform performance can be achieved no matter a base is made of metal or plastic.
3. The miniaturized vehicle-mounted combined antenna covers a wider frequency range.
4. The GNSS active antenna in the miniaturized vehicle-mounted combined antenna supports a multi-constellation combination including GPS L1, BEIDOU BII, GLONASS G1, and GALILEO E1, through one GNSS receiving module, a power division feeding network is adopted on the circuit board 3 to achieve output of two signals, one signal is provided to vehicle computer navigation to use the P-BOX, and the other signal is provided to the T-BOX for use, which achieves a low cost.

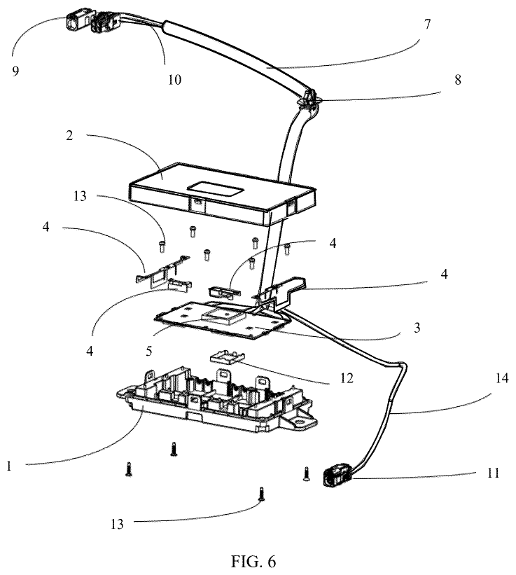

Based on the above embodiments, as shown in FIG. 6, FIG. 6 shows a schematic exploded view of a six-in-one combined antenna.

The six-in-one combined antenna includes: a first housing 2, a second housing 1, a GNSS active antenna, a second wiring harness and a third wiring harness that are connected with the GNSS active antenna, a plurality of first antennas (e.g., a 5G Main antenna, a 5G diversity antenna, and two 5G MIMO antennas), a first wiring harness connected with the plurality of first antennas 4, fleece tape 7, a cable tie chip 8, a circuit board 3, a shielding cover 12, and screws 13.

The first housing 2 is engaged with the second housing 1, and the second housing 1 and the first housing 2 are fixed through the screws 13. The 5G Main antenna (5G-Main), the 5G diversity antenna (5G-DIV), and the two 5G MIMO antennas (5G-MIMO1, 5G-MIMO2) are hot-melted in the first housing 2, and the 5G Main antenna, the 5G diversity antenna, the two 5G MIMO antennas, and the GNSS active antenna are welded to the circuit board 3.

A connector 9 of the first wiring harness is connected with the first antennas 4 on the circuit board 3 through a radio frequency cable 14. The assembling stability of the six-in-one combined antenna is ensured while achieving the antenna performance. The 5G Main antenna and the 5G diversity antenna may be blind-mated, which ensures the assembling conciseness and convenience of the antenna.

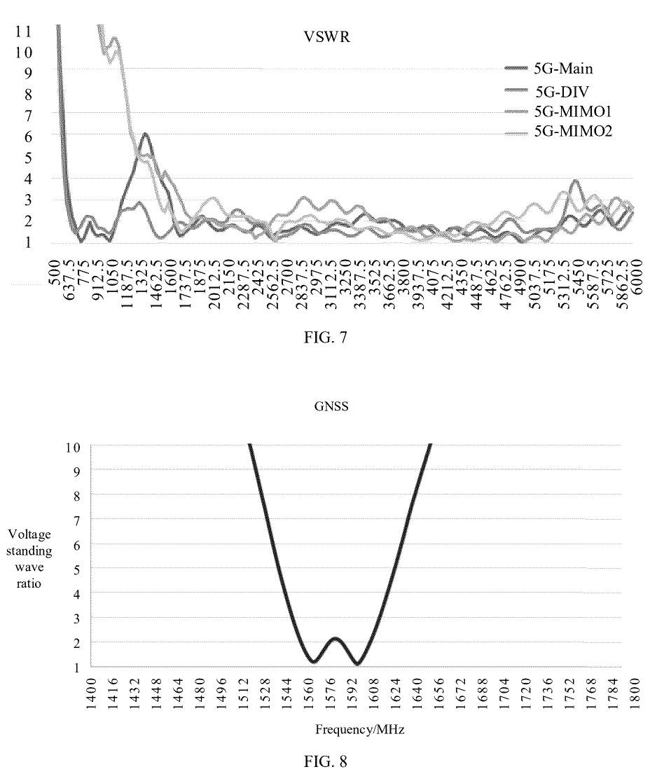

The performance of the above six-in-one combined antenna is described below with reference to FIG. 7 to FIG. 9.

FIG. 7 shows a schematic diagram of voltage standing wave ratios of respective first antennas 4. An abscissa axis is a frequency, an ordinate axis is a voltage standing wave ratio (VSWR), which refers to a ratio of a voltage peak value to a voltage valley value of a standing wave on a line. The larger the standing wave ratio, the higher reflecting power, and the lower transmission efficiency. It can be seen that, the VSWRs of four first antennas 4 in the six-in-one combined antenna may reach 3 or below.

FIG. 8 shows a schematic diagram of a voltage standing wave ratio of a second antennas 5. An abscissa axis is a frequency, and an ordinate axis is a voltage standing wave ratio VSWR. It can be seen that, a VSWR of the GNSS active antenna may reach about 2.

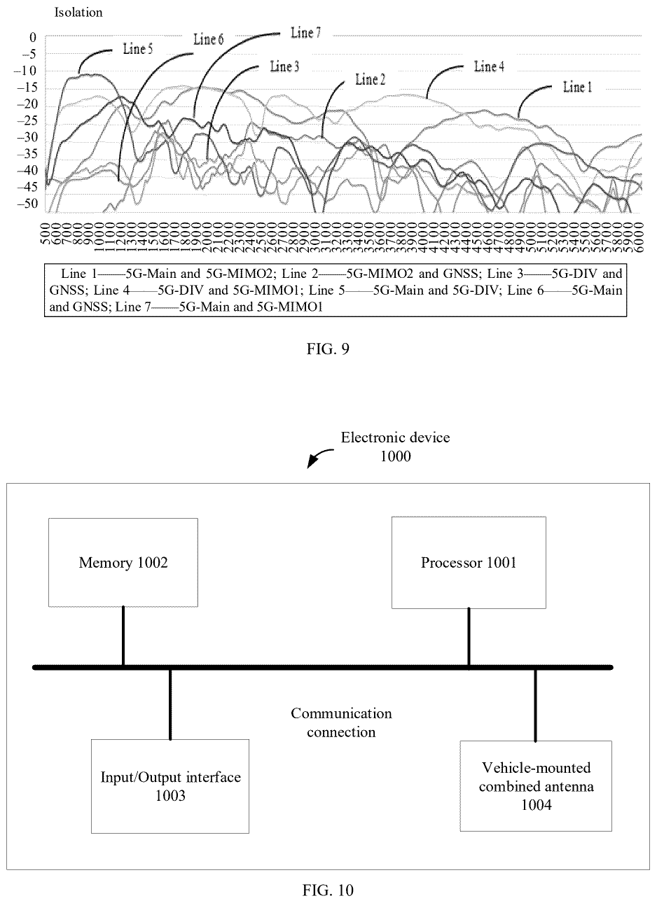

FIG. 9 shows isolation between antennas. An abscissa axis is a frequency, and an ordinate axis is isolation. In FIG. 9, Line 1 represents isolation between 5G-Main and 5G-MIMO2, Line 2 represents isolation between 5G-MIMO2 and the GNSS active antenna, Line 3 represents isolation between 5G-DIV and the GNSS active antenna, Line 4 represents isolation between 5G-DIV and 5G-MIMO1, Line 5 represents isolation between 5G-Main and 5G-DIV, Line 6 represents isolation between 5G-Main and the GNSS active antenna, and Line 7 represents isolation between 5G-Main and 5G-MIMO1. It can be seen that, the isolation between the first antennas 4, and the isolation between the first antennas 4 and the second antennas 5 in the six-in-one combined antenna both meet requirements.

Based on the above embodiments, an embodiment of the present application further provides an electronic device. The electronic device includes the vehicle-mounted combined antenna provided in the above embodiment, a telematics communication unit, and a vehicle positioning module. The vehicle-mounted combined antenna is connected with the telematics communication unit and the vehicle positioning module. The electronic device may be, for example, a vehicle-mounted device, or a roadside unit or the like. As shown in FIG. 10, FIG. 10 shows a structural block diagram of an electronic device. The electronic device includes a memory 1002, a processor 1001, an input/output interface 1003 as well as a telematics communication unit, a vehicle positioning module, and a vehicle-mounted combined antenna 1004. The memory 1002, the processor 1001, and the input/output interface 1003 are connected through an internal connection channel. The telematics communication unit and the vehicle positioning module are connected with the processor 1001. The memory 1002 is configured to store instructions. The processor 1001 is configured to execute the instructions stored in the memory 1002. The vehicle-mounted combined antenna 1004 is configured to receive various forms of external signals and transmit the signals to the telematics communication unit and the vehicle positioning module, and the signals are provided to the processor 1001 by the telematics communication unit and the vehicle positioning module.

It is to be understood that, in the embodiment of the present application, the processor 1001 may include a general-purpose central processing unit (CPU), a microprocessor, an application-specific integrated circuit (ASIC) or one or more integrated circuits, and is configured to execute related programs.

The memory 1002 may include a read-only memory and a random access memory, and provide instructions and data to the processor 1001. A part of the processor 1001 may further include a non-volatile random access memory. For example, the processor 1001 may further store information about device types.

The processor may be a central processing unit (CPU), and the processor may also include another general-purpose processor, a digital signal processor (DSP), an application specific integrated circuit (ASIC), a field programmable gate array (FPGA) or another programmable logic device, a discrete gate or a transistor logic device, a discrete hardware component, or the like. The general-purpose processor may include a microprocessor, or the processor may also include any conventional processor, or the like.

It is to be noted that, in implementations, unless there is a specific definition on articles in the text, “one,” “a,” “said,” and “the” may also include plural forms. If descriptions such as “first”, “second”, and “third” are involved in the embodiments of the present disclosure, the descriptions such as “first”, “second”, and “third” are only for descriptive purposes and cannot be understood as indicating or implying their relative importance or implicitly specifying the quantity of technical features indicated. Therefore, features that are defined by “first” and “second” can explicitly or implicitly include at least one of these features.

The above is only the detailed description of the present application, but the scope of protection of the present application is not limited to this. Changes or replacements that can be easily obtained by any person skilled in the art within the technical scope disclosed in the present application should be covered in the scope of protection of the present application. Thus, the scope of protection of the present application shall be subject to the scope of protection of the claims.

What is claimed is:

1. A vehicle-mounted combined antenna, comprising a circuit board, a first wiring harness, a second wiring harness and a third wiring harness, wherein
the circuit board is provided with a plurality of first antennas and at least one second antenna, the first wiring harness is connected with the plurality of first antennas through the circuit board, the second wiring harness and the third wiring harness are both connected with the second antenna through the circuit board; and
the first wiring harness and the second wiring harness are connected with a telematics communication unit, and the third wiring harness is connected with a vehicle positioning module.

2. The vehicle-mounted combined antenna according to claim 1, wherein the second antenna is arranged in a central area of the circuit board, and the plurality of first antennas are arranged on three sides of the circuit board.

3. The vehicle-mounted combined antenna according to claim 1, wherein a first antenna having high antenna frequency among the plurality of first antennas is arranged on a long side of the circuit board, and a first antenna having a low antenna frequency among the plurality of first antennas is arranged on a short side of the circuit board.

4. The vehicle-mounted combined antenna according to claim 1, further comprising a shielding cover, wherein the shielding cover is arranged in a central area of a side face, facing away from the second antenna, of the circuit board.

5. The vehicle-mounted combined antenna according to claim 1, further comprising a power division feeding module, wherein the power division feeding module is located on the circuit board and arranged between the second antenna and the second and third wiring harnesses.

6. The vehicle-mounted combined antenna according to claim 1, further comprising a first housing and a second housing, wherein the first housing and the second housing are snap-fitted to form an accommodating chamber, the circuit board is mounted in the accommodating chamber, and the first wiring harness, the second wiring harness and the third wiring harness extend out of the accommodating chamber.

7. The vehicle-mounted combined antenna according to claim 6, wherein the plurality of first antennas are hot-melted on the first housing by using steel sheets.

8. The vehicle-mounted combined antenna according to claim 1, wherein the plurality of first antennas comprise two 5G multiple-input multiple-output (MIMO) antennas, one 5G Main antenna and one 5G diversity antenna, and the second antenna is a ceramic high-precision positioning antenna or a global navigation satellite system (GNSS) active antenna.

9. The vehicle-mounted combined antenna according to claim 6, wherein a fixing lug is arranged on a short side of the first housing, the fixing lug comprises a reinforcing rib and a fixing sheet, and the fixing sheet is provided with a fixing hole.

10. The vehicle-mounted combined antenna according to claim 7, wherein a fixing lug is arranged on a short side of the first housing, the fixing lug comprises a reinforcing rib and a fixing sheet, and the fixing sheet is provided with a fixing hole.

11. An electronic device, comprising: a telematics communication unit, a vehicle positioning module and a vehicle-mounted combined antenna,
wherein the vehicle-mounted combined antenna comprises a circuit board, a first wiring harness, a second wiring harness and a third wiring harness, the circuit board is provided with a plurality of first antennas and at least one second antenna, the first wiring harness is connected with the plurality of first antennas through the circuit board, the second wiring harness and the third wiring harness are both connected with the second antenna through the circuit board, the first wiring harness and the second wiring harness are connected with a telematics communication unit, and the third wiring harness is connected with a vehicle positioning module; and
the vehicle-mounted combined antenna is connected with the telematics communication unit and the vehicle positioning module.

12. The electronic device according to claim 11, wherein the second antenna is arranged in a central area of the circuit board, and the plurality of first antennas are arranged on three sides of the circuit board.

13. The electronic device according to claim 11, wherein a first antenna having high antenna frequency among the plurality of first antennas is arranged on a long side of the circuit board, and a first antenna having a low antenna frequency is arranged on a short side of the circuit board.

14. The electronic device according to claim 11, wherein the vehicle-mounted combined antenna further comprises a shielding cover, the shielding cover is arranged in a central area of a side face, facing away from the second antenna, of the circuit board.

15. The electronic device according to claim 11, wherein the vehicle-mounted combined antenna further comprises a power division feeding module, the power division feeding module is located on the circuit board and arranged between the second antenna and the second and third wiring harnesses.

16. The electronic device according to claim 11, wherein the vehicle-mounted combined antenna further comprises a first housing and a second housing, the first housing and the second housing are snap-fitted to form an accommodating chamber, the circuit board is mounted in the accommodating chamber, and the first wiring harness, the second wiring harness and the third wiring harness extend out of the accommodating chamber.

17. The electronic device according to claim 16, wherein the plurality of first antennas are hot-melted on the first housing by using steel sheets.

18. The electronic device according to claim 11, wherein the plurality of first antennas comprise two 5G MIMO antennas, one 5G Main antenna and one 5G diversity antenna, and the second antenna is a ceramic high-precision positioning antenna or a GNSS active antenna.

19. The electronic device according to claim 16, wherein a fixing lug is arranged on a short side of the first housing, the fixing lug comprises a reinforcing rib and a fixing sheet, and the fixing sheet is provided with a fixing hole.

20. The electronic device according to claim 17, wherein a fixing lug is arranged on a short side of the first housing, the fixing lug comprises a reinforcing rib and a fixing sheet, and the fixing sheet is provided with a fixing hole.
